(19) United States
(12) Patent Application Publication
(10) Pub. No.: US 2014/0145537 A1
(43) Pub. Date: May 29, 2014

(54) ELECTRIC MOTOR HAVING AN APPROXIMATED ELLIPSOID SHAPED ROTOR

(71) Applicant: FXQ Engineering Group, LLC, Naugatuck, CT (US)

(72) Inventors: Filipe Goncalves, Naugatuck, CT (US); Chong Kyu Kim, Fort Lee, NJ (US)

(73) Assignee: FXQ Engineering Group, LLC, Naugatuck, CT (US)

(21) Appl. No.: 14/168,511

(22) Filed: Jan. 30, 2014

Related U.S. Application Data
(63) Continuation of application No. PCT/US2013/021398, filed on Jan. 14, 2013.
(60) Provisional application No. 61/595,787, filed on Feb. 7, 2012.

(51) Int. Cl. H02K 1/22; H02K 15/02; H02K 1/17

(52) U.S. Cl. CPC H02K 1/22; H02K 1/17; H02K 15/02
USPC 310/154.01; 310/261.1; 29/598

(57) ABSTRACT

In one embodiment, a motor has a rotor with an approximated ellipsoid shape defined by a plurality of lattice lines and a plurality of lattice points. The motor has a matching stator that is configured to be utilized in conjunction with the approximated ellipsoid shaped rotor and to accommodate the approximated ellipsoid shaped rotor. The motor may also includes a housing unit configured to hold the matching stator that is utilized in conjunction with the approximated ellipsoid shaped rotor, and an enclosure lid configured to be used by the housing unit. The enclosure lid may be configured to hold the rotor having the approximated ellipsoid shape with a bearing.

### RELATED APPLICATIONS

The present application is a continuation of copending PCT Patent Application No. PCT/US2013/021398, which was filed on Jan. 14, 2013, by FXQ Engineering Group, LLC for an “Electric Motor Having an Approximated Ellipsoid Shaped Rotor”, which claims priority to U.S. Provisional Patent Application No. 61/595,787 filed on Feb. 7, 2012 by Filipe Goncalves, entitled “Lattice Lines of an Ellipse in Electric Motor Applications”, the contents of both of which are incorporated by reference herein in their entirety.

### BACKGROUND

1. Technical Field

The present application relates to electric motor design, and more specifically to an electric motor having an approximated ellipsoid shaped rotor, shaped according to lattice lines of an ellipse, and a stator that can house the approximated ellipsoid shaped rotor.

2. Background Information

Electric motors may be broadly classified into alternating current (AC) motors and direct current (DC) motors. AC motors generally include two basic mechanical parts, an outside stationary stator having coils supplied with alternating current to produce a rotating magnetic field, and an inside rotor attached to a shaft that is given a torque by the rotating field. The stator typically operates electrically as an armature.

One common type of AC motor is the induction motor, in which the field on the rotor is created by an induced current. Induction motors make up approximately 80% of the total AC motor population, mostly as a result of their simple, yet robust construction, which lends itself to low cost manufacturing. They generally run at speeds proportional to the frequency of the supplied AC.

Most common AC motors use a squirrel-cage rotor design. A squirrel-cage rotor is a cylindrically shaped rotor constructed from rotor bars that span the length of the rotor, that are connected through a ring at each end, forming a cylindrical cage-like structure. A core of the squirrel-cage rotor is typically constructed from a stack of conductive laminations. The conductive laminations may be slightly tilted along the length of the rotor, to reduce noise and smooth out inevitable torque fluctuations that occur due to interactions with pole pieces of the stator. The structure of a squirrel-cage rotor may be prone to eddy current loss, and exotic materials and time consuming manufacturing techniques may be required to reduce the eddy current loss.

DC motors generally are structured differently than AC motors, due to the differing nature of direct current. Generally, DC motors have a cylindrically shaped rotor that operates electrically as an armature and a stator that provides a static field winding or permanent magnet. The windings on the cylindrically shaped rotor carry current, which, in turn, creates magnetic fields perpendicular to the lines of flux of the static field winding or permanent magnet. The DC motor rotates as a result of two magnetic fields attracting and pulling from each other. DC motors include a mechanism that periodically reverses the current direction between the rotor and static field winding or permanent magnet, to maintain the perpendicularity. In general, DC motors may offer speed control and high torque startability.

Types of DC motors include brushed DC motors and brushless DC (BLDC) motors. A brushed DC motors typically utilizes a plurality of slip rings (otherwise known as brushes) that interface with a commutator that resides on the rotor. The commutator generally takes the form of a conductive circle or band having segments attached to different rotor windings. As the rotor turns, the brushes slide over the commutator, and make electrical contact with different segments, generating a dynamic magnetic field. Over time, brushes wear out and need to be replaced. As brushes wear out, efficiency of the motor begins deteriorating and the motor can ultimately stop functioning.

A BLDC motor, unlike a brushed design, typically does not rely upon mechanical structures to reverse the current and generate the dynamic magnetic field. Rather, BLDC motors typically utilize electronics (e.g., an inverter and Hall effect sensors) to carry out this function. While there are no brushes to wear out, BLDC motors offer other challenges and currently make up only a minority of the overall DC motor population.

While AC and DC motors differ in various ways, as described above, both have traditionally relied upon some form of cylindrically shaped rotors. The cylindrical shape has been maintained through many generations of motor evolution. While various attempts have been made to improve electric motor operational characteristics, including efficiency and noise production, such attempts have generally not changed the underlying shape of the rotor.

### SUMMARY

In one embodiment, the operational characteristics of an electric motor are improved by employing an approximated ellipsoid shaped rotor, shaped according to lattice lines of an ellipse, and a stator that can house the approximated ellipsoid shaped rotor. The approximated ellipsoid shaped rotor may be shaped according to the three-dimensional (3D) shape formed from the revolution about an axis of an approximation of an ellipse, where curved portions have been replaced by lattice lines of the ellipse. The revolution of one or more lattice lines of the ellipse about the axis creates a shape referred to as a 3D lattice line of an ellipse (3D-LLE), and, thereby, a rotor shape based upon a 3D-LLE shape may be referred to as 3D-LLE rotor. A matching stator may accommodate such a 3D-LLE rotor.

As discussed above, the shape of an approximated ellipsoid shaped rotor may be derived from the mathematical foundation of an ellipsoid and its defined limits. A beginning cylindrical mass may be chosen for the manufacturing of the approximated ellipsoid shaped rotor. An ellipse, having a plurality of lattice points and a plurality of lattice lines, may be selected to be utilized in the manufacture of the approximated ellipsoid shaped rotor from the beginning cylindrical mass. An approximation of the selected ellipse, where curved portions have been replaced by lattice lines of the ellipse, when revolved about the axis, may define the shape of the rotor. A matching stator may be manufactured so that its inner surface is parallel to the approximated ellipsoid shaped rotor. In this manner, its shape is also defined by the lattice lines of the ellipse. Alternatively, the inner surface of the matching stator may be cylindrical. The approximated ellipsoid shaped rotor and matching stator may be assembled, with the approximated ellipsoid shaped rotor placed into the matching stator, and a coil of the stator wound on an outer or inner surface of the stator. A housing unit may be provided to hold the stator. An enclosure lid may be coupled to the housing unit and hold the approximated ellipsoid shaped rotor with a bearing.

Advantageously, an electric motor employing an approximated ellipsoid shaped rotor, shaped according to lattice lines of an ellipse, may provide lower amperage consumption, higher power factor, higher efficiency, higher torque, faster rotation (at the same torque output), and a better self-equilibrium than electric motors employing conventional cylindrically shaped rotors. Such improvements may be achieved regardless of the form of the electric motor, whether it be an AC motor, a brushed DC motor, a BLDC motor, or another type of motor. Furthermore, the rotor shape is equally applicable to generators of a variety of different types.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A and 1B are a representation of an example ellipsoid, and a representation of an example ellipse, respectively;

FIGS. 2A and 2B depict an example full approximation of an ellipse, and an example single side approximation of the ellipse, respectively;

FIGS. 3A-3C depict a plurality of example ellipses that may qualify for the “ellipse dictating rotor surface” (EDRS) method and/or the “rotor surface dictating ellipse” (RSDE) method;

FIG. 4 depicts an example ellipse that may be used to illustrate operation of the EDRS method;

FIG. 5 is a flow chart of an example procedure for translating an ellipse to a set of final dimensions according to the EDRS method;

FIGS. 6A and 6B depict an example pre-determined cross section of a rotor surface, and an example fitted ellipse, respectively;

FIG. 7 illustrates an example procedure for translating an ellipse to a set of final dimensions to manufacture a rotor and corresponding stator according to the RSDE method; and

FIG. 8 is an example procedure for assembling a motor having an approximated ellipsoid shaped rotor (e.g. a 3D-LLE rotor).

### DETAILED DESCRIPTION

### I. Definition of Terms

As used herein, the term “ellipse” shall be understood to refer to a smooth closed curve that is symmetric about its horizontal and vertical axes. The distance between antipodal points on the ellipse, or pairs of points whose midpoint is at the center of the ellipse, is at a maximum along a major axis (transverse diameter), and at a minimum along a perpendicular minor axis (conjugate diameter). For example, the equation of an ellipse whose major and minor axes coincide with Cartesian axes may be defined as:

$${( \frac{x}{a} )}^{2} + {( \frac{y}{b} )}^{2} = 1.$$

where a and b are a pair of equatorial radii (along the x- and y-axes). The a and b are fixed positive numbers determining a shape of the ellipse.

As used herein, the term “ellipsoid” is a higher dimensional analogue of an ellipse. An ellipsoid may be created as a revolution of an ellipse about an axis, such as its major axis, to create a 3-D form. For example, an equation for an ellipsoid whose axes coincide with Cartesian axes may be defined as:

$$\frac{{x}^{2}}{{a}^{2}} + \frac{{y}^{2}}{{b}^{2}} + \frac{{z}^{2}}{{c}^{2}} = 1 ,$$

where a and b are a pair of equatorial radii (along the x- and y-axes) and c is a polar radius (along the z-axis). The a, b, and c are fixed positive numbers determining a shape of the ellipsoid.

As used herein, the term “lattice point” refers to a point that, in reference to a plane orthogonal coordinate system, has coordinates, e.g., (x, y) coordinates, that are integers. For example, a lattice point is where two gridlines used in a coordinate system generally meet or intersect.

As used herein, the term “lattice point of an ellipse” or simply “LPE” refers to a lattice point that coincides with (i.e. falls exactly on) the boundary of an ellipse. When given a formula for an ellipse, it may be possible to derive the lattice points on the boundary of the ellipse.

As used herein, the term “lattice line of an ellipse” or simply “LLE” refers to a straight line segment that originates at a lattice point of an ellipse, or connects two lattice points of the ellipse. For example, a single lattice point line is a line segment that originates at a lattice point of the ellipse and extends to a terminating point that is within or on the boundary of an ellipse and is not a lattice point. Conversely, a dual lattice point line is a line segment that connects two lattice points of the ellipse.

As used herein, the term “approximated ellipsoid shaped rotor” refers to a rotor that has been shaped as, or includes one or more lines or curves derived from, an ellipsoid or a portion of an ellipsoid. The surface of an approximated ellipsoid shaped rotor need not have a smooth curvature. For example, an approximated ellipsoid shaped rotor may be formed from the revolution about an axis of an approximation of an ellipse, where curved portions have been replaced by lattice lines of the ellipse.

As used herein, the term “3D lattice line of an ellipse” or simply “3D-LLE” refers to a shape created by revolution of one or more lattice lines of an ellipse about an axis to create a 3D form.

As used herein, the term “3D-LLE rotor” refers to a rotor shaped based upon a 3D-LLE.

As used herein, the term “matching stator”, in relation to a rotor, refers to a stator that can accommodate the rotor. For example, a matching stator of a 3D-LLE rotor may be shaped so that its inner surface is parallel to the 3D-LLE rotor, or, alternatively, shaped in a different manner, provided that the 3D-LLE rotor may fit inside.

As used herein, the term “ellipse dictating rotor surface (EDRS) method” refers to steps taken to translate a selected ellipse to a rotor surface.

As used herein, the “rotor surface dictating ellipse (RSDE) method” refers to steps taken to establish a desired rotor surface and then to subsequently find an ellipse to define the desired rotor surface.

### II. Exemplary Embodiments

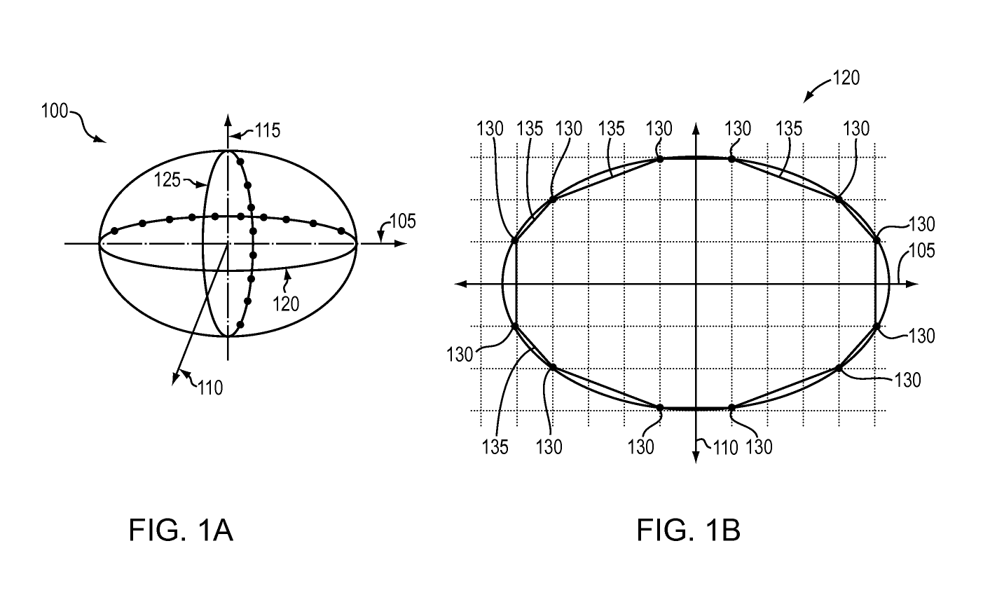

FIG. 1A is a representation of an ellipsoid 100. The ellipsoid 100 may be centered upon axes 105, 110, 115. The ellipsoid 100 may be envisioned as a revolution of ellipse 120 or ellipse 125 about respective axes. Each ellipse 120, 125 may have a plurality of corresponding lattice points (shown as dots) that may be utilized in an exemplary embodiment.

FIG. 1B is a representation of the ellipse 120 showing a plurality of lattice points of the ellipse (LPE) 130. Axis 105 defines the major axis, and axis 110 defines the minor axis, of the ellipse 120. A plurality of lattice lines of the ellipse (LLE) 135 are shown connecting the lattice points of the ellipse 130. The plurality of lattice lines of the ellipse 135 may define an approximate shape of the ellipse 120.

The revolution of the lattice lines of the ellipse 135 about an axis, here major axis 105, creates a surface referred to as three dimensional lattice line of an ellipse (3D-LLE). Just as lattice lines of the ellipse define an approximate shape in 2-D space, the 3D-LLE defines an approximate shape in 3-D space.

As explained in more detail below, an approximation of an ellipsoid based upon lattice lines (e.g., a 3D-LLE) may be used to define an approximated ellipsoid shaped rotor of an electric motor (e.g., a 3D-LLE rotor). The axis of such a rotor may be aligned with the axis 105 of the ellipse 120 about which the revolution of the lattice lines have been performed. A matching stator of the electric motor may be formed that can accommodate the approximated ellipsoid shaped rotor (e.g., 3D-LLE rotor). The number of lattice points, and thereby lattice lines of the ellipse, that are used in connection with the rotor may be based on specific performance needs of the electric motor. For example, eight, twelve, sixteen or some other number of lattice points, and a resulting number of lattice lines, may be used based on specific performance needs, the application of electric motor, desired price point, and/or other factors.

The approximated ellipsoid shaped rotor, shaped according to lattice lines of an ellipse, may have a configuration which indicates which lattices points and lattice lines of the ellipse 120 are used in its shaping. In one type of configuration, termed a “full approximation”, lattice points and lattice lines of the ellipse to both sides of axis 110 are utilized. In another type of configuration, termed a “single side approximation”, lattice points and lattice lines of the ellipse to only one side of axis 110 are utilized.

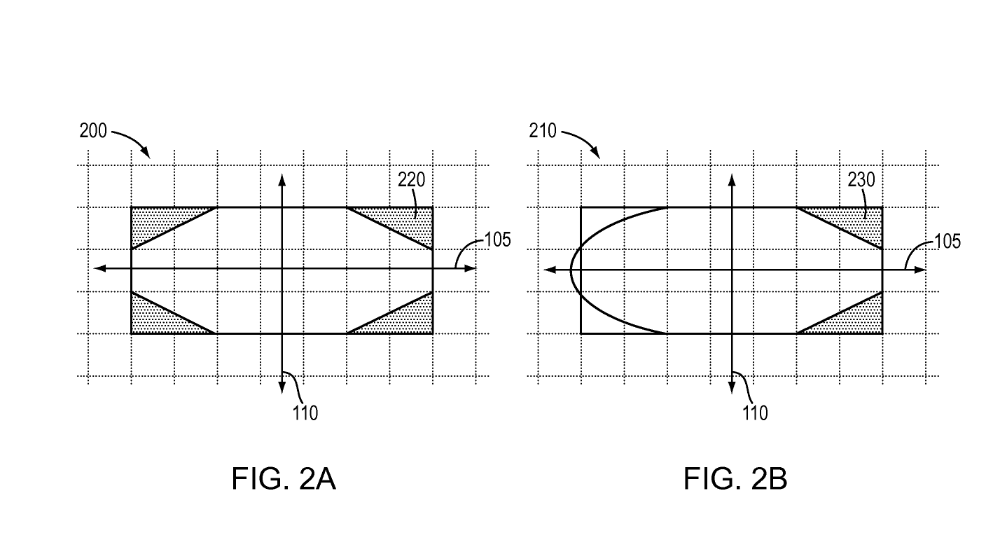

FIGS. 2A and 2B depict a full approximation 200 of an ellipse and a single side approximation 210 of the ellipse, respectively. It is noted that the ellipse has eight lattice points. In the full approximation 200, lattice points and lattice lines of the ellipse to both sides are utilized, while in the single side approximation 210 lattice points and lattice lines of the ellipse to only one side are utilized. The shaded areas 220 and 230 in FIGS. 2A and 2B may correspond to a portion that are removed through subtractive manufacturing techniques from a beginning cylinder, as known by those skilled in the art. When the approximations 200, 210 are revolved about axis 105, the shape (e.g., 3D-LLE) created may be used for an approximated ellipsoid shaped rotor, with the axis of the rotor aligned with axis 105. A choice as to which configuration (i.e., the full approximation or the single side approximation) to be utilized may be based on a balancing of a customer's performance requirements, the end application of the electric motor, and cost constraints.

An approximated ellipsoid shaped rotor, based on lattice lines of an ellipse, may be designed using a number of different methods, including an ellipse dictating rotor surface (EDRS) method and a rotor surface dictating ellipse (RSDE) method.

The EDRS method may be applicable in circumstances where, for example:
1. The number of lattice points present in the selected ellipses will be a multiple of 4, with a minimum of 8 lattice points. Exemplary ellipses would contain 8, 12, 16, 20, 24 . . . n, lattice points.
2. Each lattice point has a corresponding lattice point that is a reflection or minor isometric, about the major axis of the ellipse, which is designated the reflection axis or the associated minor.
   The RSDE method may be applicable in circumstances where, for example:
1. The number of lattice points present in the selected ellipses is a multiple of 4, with a minimum of 4 lattice points. Exemplary ellipses would contain 4, 8, 12, 16, 20, 24 . . . n, lattice points.
2. Each lattice point has a corresponding lattice point that is a reflection or minor isometric, about the major axis of the ellipse, which is designated the reflection axis or the associated minor.

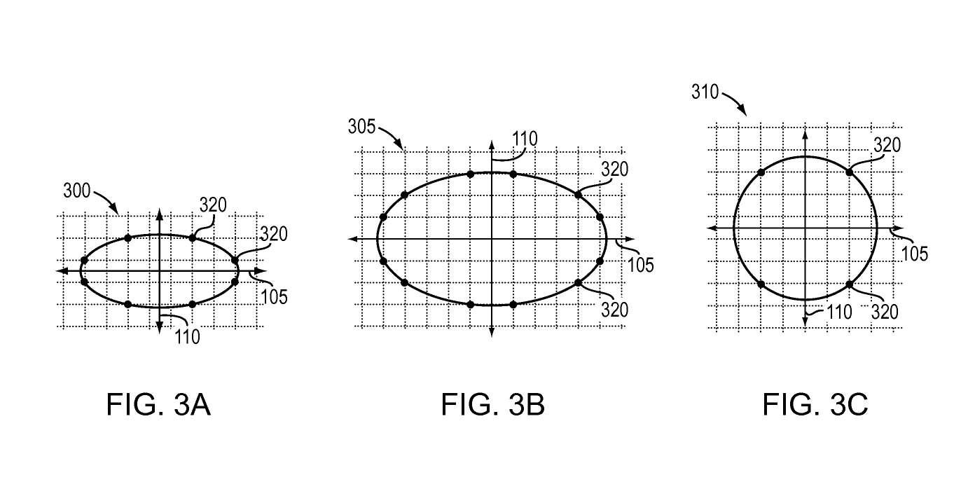

FIGS. 3A-3C depict a plurality of example ellipses that may qualify for the EDRS method and/or the RSDE method. Specifically, the ellipses 300, 305, and 310 in FIGS. 3A-3C may qualify as ellipses for the RSDE method, as they have lattice points of the ellipse 320 numbering a multiple of 4, with at least 4 lattice points, and contain lattice points with a reflection or minor isometric when the major axis 105 is defined as the reflection axis. Further, the ellipses 300 and 305 in FIGS. 3A and 3B may qualify as ellipses for the EDRS method, as they have lattice points of the ellipse 320 numbering a multiple of 4, with at least 8 lattice points, and contain lattice points with a reflection or minor isometric when the major axis 105 is defined as the reflection axis.

Upon selecting a qualifying ellipse meeting either the requirements of the EDRS and RSDE methods and selecting a configuration (e.g., full approximation or single side approximation), the ellipse may then be translated to a set of final dimensions that may be used to manufacture the approximated ellipsoid shaped rotor, shaped according to lattice lines of an ellipse, and a stator that can house the approximated ellipsoid shaped rotor. The translation to the final set of dimensions can be done utilizing the EDRS method or RSDE method as described below.

### EDRS Method:

For the EDRS method, dimensions of a cylindrical rotor of a benchmark conventional electric motor rating may first be identified. The benchmark motor may have a given horsepower rating. A surface area based on the obtained dimensions may then be calculated, where these calculated values will serve to guide the final rotor design associated with the selected ellipse. For example, if the benchmark motor has a cylindrical rotor with a radius of 15 mm and a height of 70 mm, the surface area of the cylindrical rotor is 2πRH, where R is the radius and H is the height. Thus, the benchmark motor has a cylindrical rotor with a surface area 6597.34 mm². Since the surface area of the rotor is directly proportional to the rotational energy as dictated by the Gaussian surface, (holding material choice constant) it is desirable that the approximated ellipsoid shaped rotor produced by the method has a surface area (associated with the selected ellipse, lattice points/lines and configuration) of a similar value.

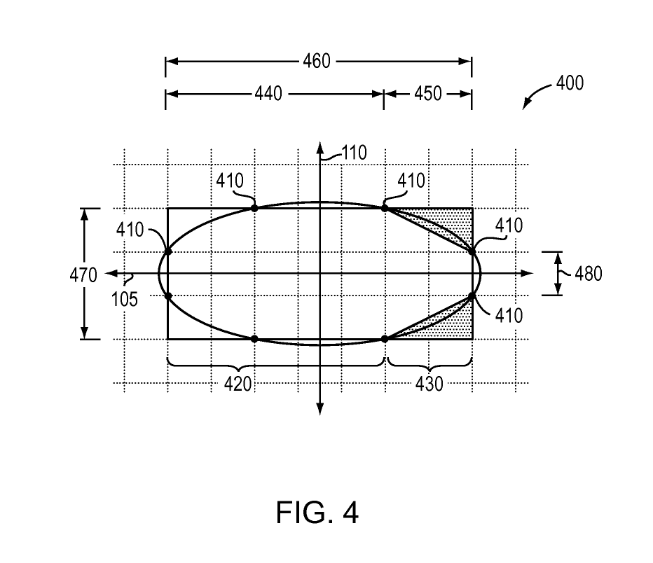

FIG. 4 depicts an example ellipse 400 that may be used to illustrate operation of the EDRS method. The ellipse 400, and its lattice points 410 and configuration (a single side approximation), may be used as a basis for a final approximated ellipsoid shaped rotor design. It is noted that while FIG. 4 depicts a single side approximation, the configuration may alternatively be a full approximation. It may be desirable for an approximated ellipsoid shaped rotor shaped from the revolution about the axis 105 of the single side approximation of the ellipse 400 to have a similar surface area to the cylindrical rotor of a benchmark motor. To that end, ratios between a generally cylinder section, formed from a revolution of a portion 420 of the approximation, and a truncated cone section, formed from revolution of portion 430 of the approximation, may be obtained. The ratios may include a height ratio between height 440 of the generally cylindrical section and height 450 of the truncated cone section, a height-to-left-side-diameter ratio between an overall height 460 to a left side diameter 470 of the generally cylindrical section 420, and a left-side-diameter-to-right-side-diameter ratio between the left side diameter 470 of the generally cylindrical section 420 and a right side diameter 480 of the truncated cone section 430. For instance, in the example in FIG. 4, the height ratio is 5:2, the height-to-left-side-diameter ratio is 7:3, and the left-side-diameter-to-right-side-diameter ratio is 3:1. An overall height may then be derived that will yield a surface area for an approximated ellipsoid shaped rotor that is close to the surface area of the cylindrical rotor of the benchmark motor.

For example, in the example of FIG. 4, it may be determined that an ellipse having a height of 72.7 mm would yield an approximated ellipsoid shaped rotor having a surface area of 6,598.36 mm², that is 0.015% different than the benchmark motor that has a surface area of 6597.34 mm². The slight difference may be well within an acceptable threshold of difference. It is noted that the surface area from the example of FIG. 4 may be derived using the formula 2πRH for the generally cylindrical section (where R is the radius and H is the height) and πl(R+r) for the truncated cone section, where l is the square root of [h²+(R−r)²], r is the radius at the right side cone end and h is the height at the cone end. Holding the ratios constant and utilizing the determined height of 72.7 mm, a scale of 10.39:1 may be obtained. The obtained scale may then be applied (e.g., by multiplying the scale value to the dimensions of the ellipse 400 in FIG. 4) to the various height and radius values to obtain the final dimensions of the approximated ellipsoid shaped rotor. Specifically, for the ellipse 400 in FIG. 4, the final dimensions may be 51.93 mm for the height of the generally cylindrical section, 20.77 mm for the height of the truncated cone section (51.93 mm+20.77 mm=72.7 mm as the overall height), 31.16 for the left side diameter, and 10.39 mm for the right side diameter.

The final dimensions of the ellipse 400 (e.g., including the lattice points of the ellipse) may then be utilized to manufacture an approximated ellipsoid shaped rotor, shaped according to lattice lines of an ellipse (e.g., a 3D-LLE rotor) using subtractive manufacturing techniques. Further, a corresponding stator having an inner surface that accommodates the rotor may be manufactured.

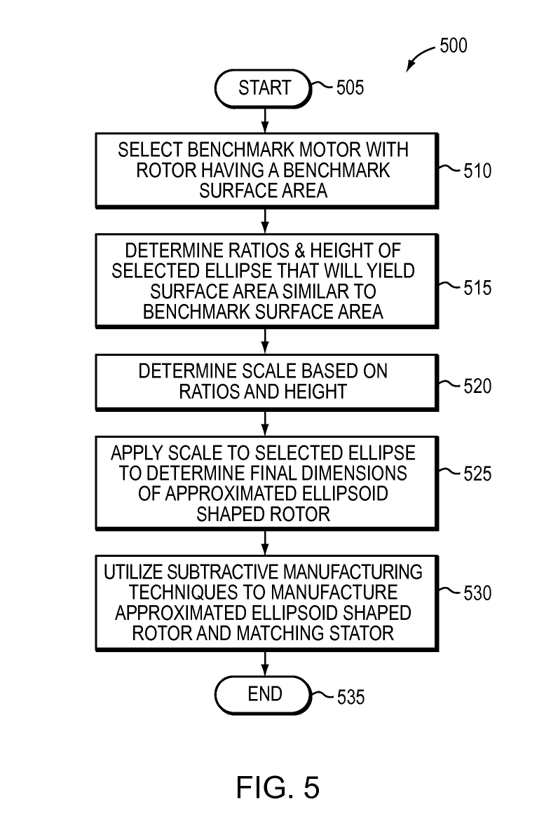

FIG. 5 is a flow chart of an example procedure 500 for translating an ellipse to a set of final dimensions according to the EDRS method. The procedure 500 starts at step 505 and continues to step 510, where a benchmark motor having a cylindrical rotor with a benchmark surface area is selected. In step 515, ratios and a height associated with a selected ellipse, having lattice points and a configuration, are determined that will yield a surface area similar to the benchmark surface area. It may be determined that the surface area is similar if the difference it is within a threshold amount. At step 520, the ratios are held constant and utilized in conjunction with the height to determine a scale. At step 525, the scale may then be applied to the selected ellipse (e.g., as depicted in FIG. 4 having the Cartesian axes) to determine the final dimensions for the approximated ellipsoid shaped rotor (e.g., the 3D-LLE rotor), and specifically the locations of the lattice points and lattice lines. At step 530, subtractive manufacturing techniques may be utilized on a cylinder to manufacture the approximated ellipsoid shaped rotor (e.g., the 3D-LLE rotor) having the final dimensions, and a matching stator may also be manufactured. At step 535, the procedure ends.

### RSDE Method:

For the RSDE method, dimensions in a cylindrical rotor of a benchmark conventional electric motor, for example, of a given horsepower rating, may first be identified. A surface area based on the obtained dimensions may then be calculated, where these calculated values will serve to guide the final rotor design associated with the selected ellipse. For example, if the benchmark motor has a cylindrical rotor with a radius of 44.5 mm and a height of 70 mm, the surface area of the benchmark rotor is 2πRH, where R is the radius and H is the height. Thus, the benchmark motor has a surface area 19,572.12 mm². Since the surface area of the rotor is directly proportional to the rotational energy as dictated by the Gaussian surface, (holding material choice constant) it is desirable that the approximated ellipsoid shaped rotor produced by the method has a surface area (associated with the selected ellipse, lattice points/lines and configuration) of similar value.

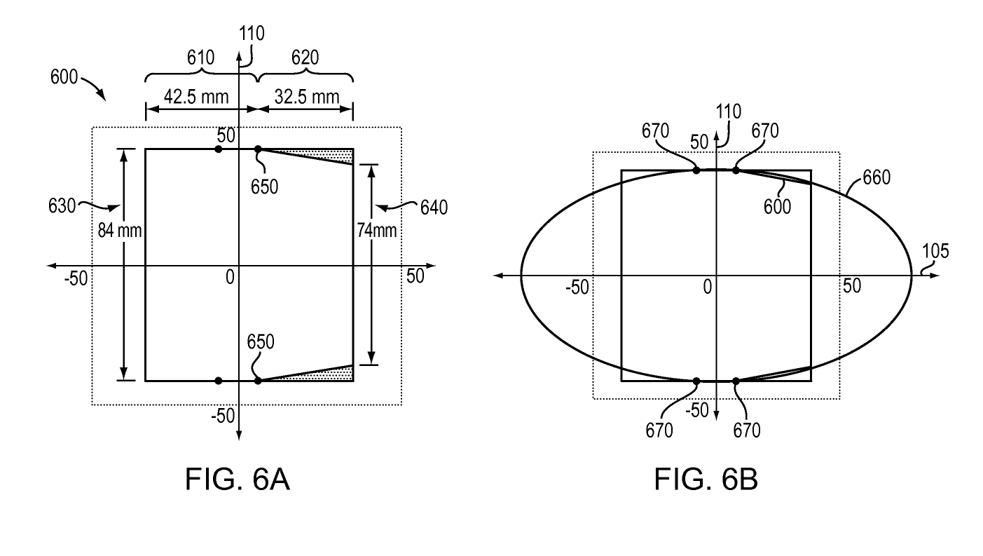

To that end, dimensions for a final approximated ellipsoid shaped rotor (e.g., 3D-LLE rotor) are determined that would yield a surface area similar to that of the benchmark surface area. FIG. 6A shows an example pre-determined cross section 600 of a rotor surface. The cross section, in this example, has a portion 610 having a height of 42.5 mm, whose revolution forms a cylinder section of the rotor, and a portion 620 having a height of 32.5 mm, whose revolution forms a truncated cone section 620 of the rotor, having a left side diameter 630 of 84 mm, and a right side diameter of 74 mm. These values produce a rotor having a surface area (utilizing the formulas described above) of 19,376.42 mm², that is 1.0% from the benchmark surface area of 19,572.12 mm² discussed above.

Now, an ellipse shape and its dimensions may be determined that will fit the pre-determined cross section 600 in FIG. 6A. FIG. 6B depicts an example fitted ellipse 660. In FIG. 6A, two points 650 are shown. These points should align with lattice points 670 of the fitted ellipse. The fitted ellipse can be determined through mathematical calculation. For example, the formula for an ellipse:

$${( \frac{x}{a} )}^{2} + {( \frac{y}{b} )}^{2} = 1$$

where a and b are a pair of equatorial radii (along the x- and y-axes). Now if a=3m₁ and b=3n₁/2√2, with m and n being positive integers, then x=m and y=n are the positive integral solution of the ellipse equation. The lattice points lying inside and on the ellipse will be the lattice points lying inside and on the rectangle of sides and along x-axis and y-axis respectively with one vertex at the origin. This may be used to determine dimensions of the approximated ellipse that fits the pre-determined rotor cross section 600. For example, it may be determined that an ellipse, having lattice points 670 at points (5, 42), (5, −42), (−5, 42) and (−5, −42) on a coordinate system formed by axes 105, 110, fits the pre-determined rotor cross section 600. The points (5, 42) and (5, −42) are the lattice points on the single point lattice lines where the truncation starts and that match the points 650 of the cross section 600.

The final dimensions of the ellipse (e.g., including the lattice points of the ellipse) may then be utilized to manufacture an approximated ellipsoid shaped rotor, shaped according to lattice lines of an ellipse (e.g., a 3D-LLE rotor) using subtractive manufacturing techniques. Further, a matching stator having an inner surface that accommodates the rotor may be manufactured.

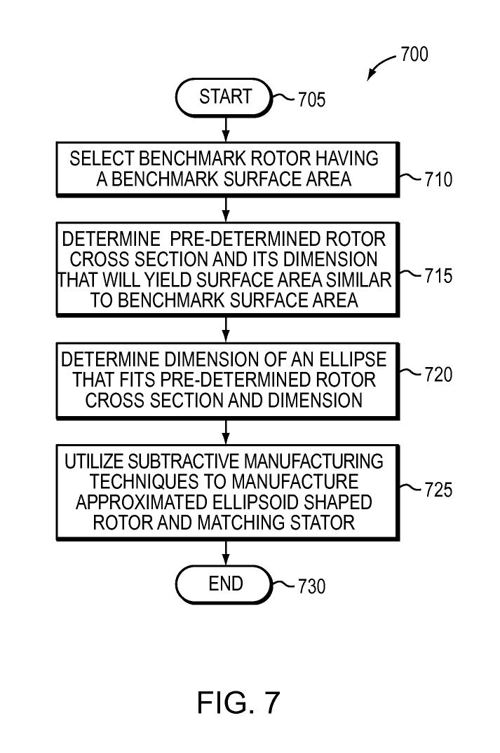

FIG. 7 is a flow chart of an example procedure 700 producing final dimensions according to the RSDE. The procedure 700 starts at 705 and continues to step 710 where a benchmark cylindrically shaped rotor is selected having a benchmark surface area. At step 715, a pre-determined rotor cross section and its dimensions are determined that will yield a surface area similar to that of the benchmark surface area. At step 720, dimensions of an ellipse that fit the pre-determined rotor cross section are determined. At step 725, subtractive manufacturing techniques may be utilized on a cylinder to manufacture the approximated ellipsoid shaped rotor (e.g. 3D-LLE rotor) having the dimensions, and a matching stator may also be manufactured. At step 730, the procedure ends.

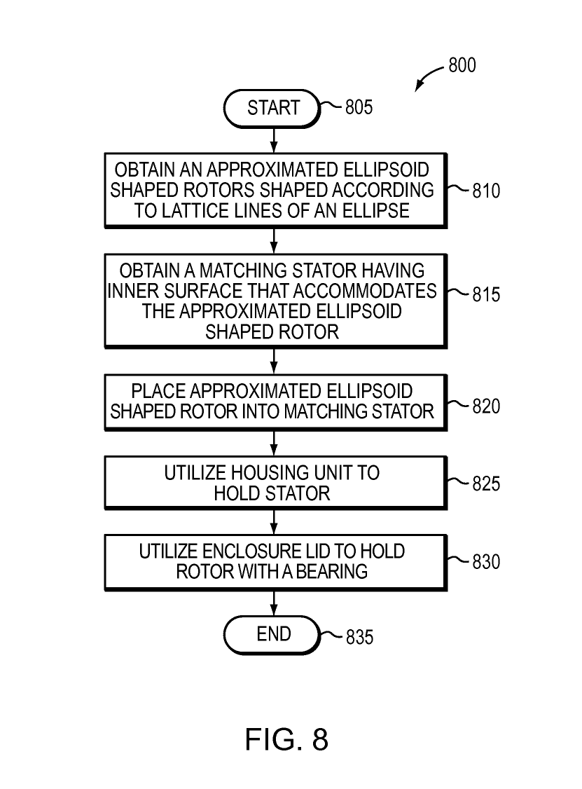

FIG. 8 is an example procedure 800 for assembling a motor having an approximated ellipsoid shaped rotor (e.g. a 3D-LLE rotor). The procedure 800 start at step 805 and continue to step 810, where an approximated ellipsoid shaped rotor (e.g., 3D-LLE rotor), shaped according to lattice lines of an ellipse, is obtained. For example, the rotor may have been manufactured using a revolution of a selected ellipse, having a plurality of lattice points and a plurality of lattice lines, and subtractive manufacturing techniques, as discussed above. At step 815, a matching stator having an inner surface that accommodates the approximated ellipsoid shaped rotor (e.g., 3D-LLE rotor) is obtained for use in conjunction with the obtained rotor. For example, the matching stator may be manufactured so that its inner surface is parallel to the approximated ellipsoid shaped rotor. Alternatively, the inner surface of the matching stator may be cylindrical. At step 820, the approximated ellipsoid shaped rotor (e.g., 3D-LLE rotor) is placed into the matching stator, and a coil associated with the stator may be wound. Further, if the approximated ellipsoid shaped rotor (e.g., 3D-LLE rotor) is an armature, and the stator includes a pair of permanent magnets, the armature may be inserted between the pair of permanent magnets. At step 825, a cylindrical housing unit is utilized to hold the matching stator. For example, if the approximated ellipsoid shaped rotor (e.g., 3D-LLE rotor) is an armature, a clip may be utilized to push the permanent magnets against a wall of the cylindrical housing. At step 830, an enclosure lid is utilized with the cylindrical housing to hold the approximated ellipsoid shaped rotor (e.g., 3D-LLE rotor) with a bearing. At step 835, the procedure ends.

The foregoing description described certain example embodiments. It will be apparent, however, that other variations and modifications may be made to the described embodiments, with the attainment of some or all of their advantages. For instance, it is expressly contemplated that the description herein may be applied to a variety of different types of electric motors, including various types of AC motors and DC motors, as well as various types of generators. Accordingly foregoing description is to be taken only by way of example, and not to otherwise limit the scope of the disclosure. It is the object of the appended claims to cover all such variations and modifications as come within the true spirit and scope of the disclosure.

What is claimed is:

1. An electric motor, comprising:
an approximated ellipsoid shaped rotor, shaped according to lattice lines of an ellipse, that extend from one or more lattice points of the ellipse;
a matching stator configured to be utilized in conjunction with the approximated ellipsoid shaped rotor and to accommodate the approximated ellipsoid shaped rotor;
a housing unit configured to hold the matching stator that is utilized in conjunction with the approximated ellipsoid shaped rotor; and
an enclosure lid configured to be used by the housing unit, the enclosure lid configured to hold the approximated ellipsoid shaped rotor with a bearing.

2. The motor of claim 1, wherein the approximated ellipsoid shaped rotor is shaped according to a revolution of the lattice lines of the ellipse about a major axis of the ellipse, the major axis of the ellipse to coincide with an axis of the rotor.

3. The motor of claim 1, wherein the matching stator has an inner surface that is parallel to a surface of the approximated ellipsoid shaped rotor, and wherein the approximated ellipsoid shaped rotor is placed within the matching stator.

4. The motor of claim 1, wherein the housing unit is a cylindrical housing unit that holds the stator.

5. The motor of claim 1, wherein the approximated ellipsoid shaped rotor operates as an armature.

6. The motor of claim 5, wherein the matching stator includes two permanent magnets, and wherein the armature is inserted between the two permanent magnets.

7. The motor of claim 1, wherein the shape of the approximated ellipsoid shaped rotor is determined based on an ellipse dictating rotor surface (EDRS) method, and a surface area associated with a cylindrical rotor of a benchmark motor.

8. The motor of claim 7, wherein the EDRS method utilizes ratios associated with the dimensions of a selected ellipse in conjunction with the surface area associated with the cylindrical rotor of the benchmark motor to obtain a scale that is applied to dimensions of the selected ellipse to obtain final dimensions associated with the approximated ellipsoid shaped rotor.

9. The motor of claim 1, wherein dimensions of the approximated ellipsoid shaped rotor are determined based on a rotor surface dictating ellipse (RSDE) method and a surface area associated with a cylindrical rotor of a benchmark motor.

10. The motor of claim 9, wherein the RSDE method utilizes dimensions of a pre-determined cross section of a rotor in conjunction with the surface area associated with the cylindrical rotor of the benchmark motor to fit an ellipse, having final dimensions, to accommodate the pre-determined cross section.

11. A method for assembling an electric motor, comprising:
obtaining an approximated ellipsoid shaped rotor, shaped according to lattice lines of an ellipse, the approximated ellipsoid shaped rotor having determined dimensions;
obtaining a matching stator having an inner surface that accommodates the approximated ellipsoid shaped rotor;
placing the approximated ellipsoid shaped into the matching stator;
utilizing a housing to hold the matching stator; and
utilizing an enclosure lid to hold the approximated ellipsoid shaped rotor.

12. The method of claim 11, wherein the approximated ellipsoid shaped rotor is shaped according to a revolution of the lattice lines of the ellipse about a major axis of the ellipse, the major axis of the ellipse to coincide with an axis of the rotor.

13. The method of claim 11, wherein the approximated ellipsoid shaped rotor is a three-dimensional lattice line of an ellipse (3D-LLE) rotor.

14. The method of claim 11, wherein the approximated ellipsoid shaped rotor operates as an armature.

15. The method of claim 11, wherein the matching stator includes two permanent magnets, and wherein the armature is inserted between the two permanent magnets.

16. The method of claim 11, wherein a configuration of the ellipse is one of a full approximation of an ellipse and a single side approximation of an ellipse.

17. The method of claim 11, wherein dimensions of the approximated ellipsoid shaped rotor are determined based on an ellipse dictating rotor surface (EDRS) method.

18. The method of claim 17, wherein the EDRS method comprises:
identifying a benchmark surface area of a cylindrical rotor of a benchmark motor;
determine ratio values and a height based on the benchmark surface area;
obtaining a scale based on the ratio values and the height; and
applying the scale to initial dimension to determine the dimensions of the approximated ellipsoid shaped rotor.

19. The method of claim 11, wherein dimensions of the approximated ellipsoid shaped rotor are determined based on a rotor surface dictating ellipse (RSDE) method.

20. The method of claim 19, wherein the RSDE method comprises:
identifying a benchmark surface area associated with a cylindrical rotor of a benchmark motor;
utilizing the benchmark surface area to obtain dimensions of a pre-determined cross section of a rotor surface; and
determining an ellipse that fit the pre-determined cross section of the rotor surface to obtain the dimensions of the approximated ellipsoid shaped rotor.
